(19) United States
(12) Patent Application Publication
(10) Pub. No.: US 2018/0330426 A1
(43) Pub. Date: Nov. 15, 2018

(54) CONSOLIDATION OF PERSONAL ITEMS INTO GIFT ORDERS

(71) Applicant: Amazon Technologies, Inc., Seattle, WA (US)

(72) Inventor: Roshan Kumar, Gurgaon (IN)

(73) Assignee: Amazon Technologies, Inc., Seattle, WA (US)

(21) Appl. No.: 14/668,716

(22) Filed: Mar. 25, 2015

(51) Int. Cl. G06Q 30/06

(52) U.S. Cl. CPC G06Q 30/0635

(57) ABSTRACT

Embodiments herein described relate to methods for providing a user of an electronic marketplace with the option to add additional items to an order placed in the electronic marketplace, the additional items being either or both of physical goods under the control of the user, or goods under the control of a third party seller unassociated with the marketplace.

### BACKGROUND

In an electronic marketplace, a user can use an internet-enabled device to place orders for a broad array of items, and to prompt the fulfillment of those orders. In some conventional systems, users can specify a delivery address, and may often take advantage of other delivery-related services, such as gift wrapping, order consolidation, expedited delivery, and gift delivery. However, conventional systems, especially those dependent on automation, are limited in the degree of personalization that can be achieved.

### BRIEF DESCRIPTION OF THE DRAWINGS

Various embodiments in accordance with the present disclosure will be described with reference to the drawings, in which:

FIG. 1 is a block diagram of an example system for enabling the fulfillment of a combined order including a user-provided item and an item from an electronic marketplace, in accordance with embodiments;

FIG. 2 is a flow chart of an example process for enabling the fulfillment of a combined order including a user-provided item and an item from an electronic marketplace, in accordance with embodiments;

FIG. 3 is a block diagram of another example system for enabling the fulfillment of a combined order including a non-marketplace item and an item from an electronic marketplace, in accordance with embodiments;

FIG. 4 is a flow chart of another example process for enabling the fulfillment of a combined order including a non-marketplace item and an item from an electronic marketplace, in accordance with embodiments; and

FIG. 5 illustrates an environment in which various embodiments can be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

An electronic marketplace may offer a broad array of products, as well as services related to the delivery of those products, for example: gift wrapping, co-packaging, expedited delivery, delivery in a reduced number of total packages, and other services. These products and services are readily available to marketplace users by way of the internet, and accessible from a broad array of devices.

However, and particularly with regard to gifting and occasion-specific deliveries, a single electronic marketplace may not be fully equipped to satisfy a user's desire to personalize or customize an order. By way of example, a user of an electronic marketplace may desire to shop for a selection of gift items from the electronic marketplace, but prefer to personalize the gift by the inclusion of a personal token or handcrafted item. In another example, a user of an electronic marketplace may prefer to personalize a gift by the inclusion of a unique or specialty item available through a seller unassociated with the electronic marketplace, which may be a different online seller, a brick-and-mortar store, a conventional offline catalog, or other suitable source.

For example, suppose Alice wishes to send a gift to Bob, but she wants to include an item that she has handcrafted. In addition, she′d like every item that is part of the gift to be delivered to Bob at the same time. To accomplish this formerly difficult task, Alice could indicate this wish at a checkout screen in an online shopping application or web browser window. Alice could then be prompted, within the web browser screen, to designate a pickup address for the personal item and a desired delivery date for the entire order and handcrafted item. A delivery agent for the electronic marketplace can depart from Alice's local, first delivery station, retrieve the handmade item from Alice's address, and transfer it through a logistical network associated with the electronic marketplace to a second delivery station near Bob. The handmade item, and each other item in Alice's order, can be held at the second delivery station until the desired delivery date, at which time a delivery agent from the second delivery station can deliver the items in the order, and the handmade item, all at once to Bob.

In accordance with at least one embodiment, an electronic marketplace may provide for the delivery of a selection of items including a custom or personalized item. The items include any suitable combination of: items obtainable by a user through the electronic marketplace; items available to the user through a seller unaffiliated with the marketplace; and items under the physical control of the user. For example, when a customer places an order in the electronic marketplace through a web service, the user may be offered an option to select a consolidated order for simultaneous delivery. Such an option may be particularly useful in the context of gift-giving, where the recipient can enjoy receiving a complete gift containing multiple parts. The user may also be offered an option to customize the order with the addition of one or more non-marketplace items. Where the order is so customized, the system may include means of: obtaining the items at a consolidation site; identifying the items as belonging to the consolidated order; determining when to fulfill the order; and fulfilling the consolidated order.

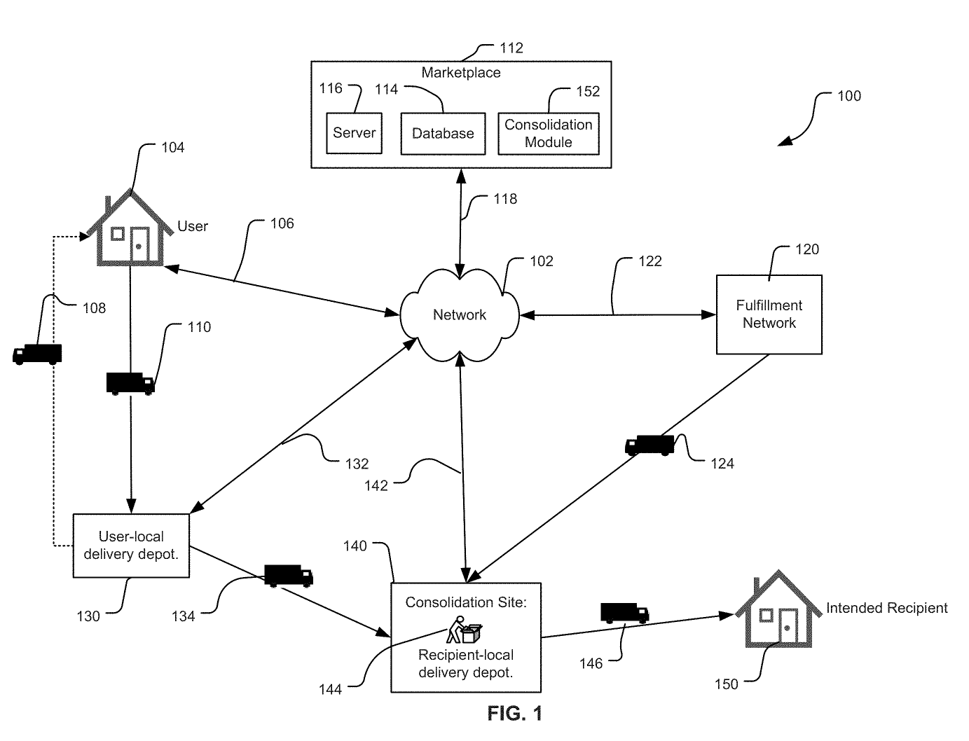

Referring now to the figures, FIG. 1 is a block diagram depicting aspects of a system for enabling the fulfillment of a combined order including a non-marketplace item and an order from an electronic marketplace, in accordance with embodiments. In the example system 100, a user 104 accesses a network 102 by way of a network connection 106. By way of the network, the user can access an electronic marketplace 112. An electronic marketplace is an online service having a server 116 for enabling online shopping, a database 114 containing at least data concerning products available in the electronic marketplace, and a consolidation module 152 for coordinating the consolidation and fulfillment of the combined order. The electronic marketplace communicates with the network 102 via a network connection 118 to provide communication with the user.

In alternative embodiments, the consolidation module 152 may include subcomponents of the server 116, or may be housed in infrastructure that is geographically distinct from other components of the electronic marketplace 112. For example, the consolidation module 152 may be housed in infrastructure co-located with one or more elements of the fulfillment network 120, for example at one or more fulfilment centers; or may be distributed. Portions of the consolidation module may operate from a cloud computing datacenter, or from a network of the delivery depots including the consolidation site 140.

The consolidation module 152 may receive indications from the marketplace 112 with respect to consolidated orders. For example, the marketplace 112 may indicate that the items in an order require consolidation processing. The marketplace 112 may maintain one or more user interfaces, including graphical user interfaces (GUIs) and programmatic interfaces such as application programming interfaces (APIs), capable of causing generation of consolidated orders. The consolidation module 152 may be notified responsive to generation of consolidated orders. Alternatively, or in addition, the consolidation module 152 may maintain one or more user interface elements suitable for incorporation and/or invocation to facilitate generation of a consolidated order. For example, such user interface elements may enable users to mark and/or tag (collectively “tag”) items as part of a consolidated order and/or to add non-marketplace items into the consolidated order. The marketplace 112 may interact with the consolidation module 152 in real-time. Alternatively, or in addition, the marketplace 112 may interact with the consolidation module 152 via a batch mode, for example, via records in the database 114.

Responsive to the indications received from the marketplace 112, the consolidation module 152 may interact and/or cause interaction with the user 104, the delivery service 108, the fulfillment network 120, the user-local delivery depot 130, the consolidation site 140, and/or any suitable order consolidation implementation component. Such interactions may include sending and/or receiving indications and/or messages (e.g., human-readable messages such as postal mail and email, and computer-readable messages such as messages of a consolidated order protocol), causing order consolidation actions (e.g., via a programmatic interface), and/or determining order consolidation status (e.g., a state of an order consolidation workflow). Order consolidation actions may include transfer of items to and/or from the user location 104, the user-local delivery depot 130, the fulfillment network 120 and the consolidation site 140, as well as to the intended recipient 150 from the consolidation site 140. The consolidation module 152 may configure and/or cause configuration of control and/or logistical systems (e.g., computer-controlled systems) at the consolidation site 140 so as to cause the consolidation site 140 to collect the items of the consolidated order, including non-marketplace items, prior to transferring the collected items to the intended recipient 150. Completing collection of the items in the consolidated order at the consolidation site 140 may act as a trigger to cause transfer of the collected items to the intended recipient 150. Incomplete collection of the items in the consolidated order at the consolidation site 140 may act as a bar to transfer of the incomplete collection to the intended recipient 150.

For example, the consolidation module 152 may communicate a collection of item identifiers corresponding to the items in a consolidated order to an electronic database of items maintained by and/or on behalf of the consolidation site 140. The electronic database of items may identify items currently located at the consolidation site 140, items currently expected to arrive at the consolidation site 140, items that previously resided at the consolidation site 140, and any suitable item status including exceptions such as item damaged, item unidentifiable, item misidentified, item missing, and so on. A logistical system controlling the consolidation site 140 may ensure that each item in the consolidated order is currently located at the consolidation site 140 (e.g., by matching item identifiers) before generating a shipping order for the consolidated order.

The consolidation module 152 may further generate, or cause generation of, instructions to transfer non-marketplace items from third-party locations such as the user location 104. For example, such instructions may be communicated to the user and/or a suitable delivery service, and may include packaging instructions, shipping labels, bar code labels, and any suitable logistical system integration components. The consolidation module 152 may also generate, or cause generation of, instructions for transferring non-marketplace items from a third-party where the user 104 is an intended intermediary for communicating instructions to a third-party seller. For example, such instructions may be communicated to the user and/or a suitable delivery service, and may include packaging instructions, a destination address, and any suitable logistical system designators such as information designating an order as part of a consolidated order; and such instructions may further include forwarding instructions addressed to or concerning the user, for instructing the user on a procedure for correctly providing the instructions to the third-party seller.

In accordance with embodiments, the electronic marketplace 112 may provide an option to include or consolidate 144 a user-controlled non-marketplace item with an order at a consolidation site 140. In this example, the consolidation site is a delivery depot associated with the electronic marketplace that is proximate, or logistically convenient, to the intended recipient 150; but the consolidation site may be any suitable, logistically convenient site within the fulfillment network. The consolidation site may also have a network connection 142 with the network 102, so that the consolidation site can update the electronic marketplace 112 with information concerning, for example, the completeness of the order; or receive instructions regarding consolidation, packaging, date or time of delivery, or other instructions.

In embodiments of the example system 100, the order may contain items obtained through the electronic marketplace 112. In such embodiments, the electronic marketplace 112 may communicate over the network 102 with portions of a fulfillment network 120, which may contain warehouses, associated third-party sellers, and various logistical components; and arrange for the transfer 124 of the marketplace items to the consolidation site 140.

In some embodiments of the example system 100, the user 104 is provided with a pickup service for transferring the non-marketplace item to the consolidation site. In embodiments, the user 104 communicates the presence of a user-controlled item to the marketplace 112 by way of the network 102 and network connections 106, 118. The marketplace 112 then communicates with a user-local delivery depot 130, e.g., potentially under the control of the electronic marketplace, by way of the network 102 and network connections 118 and 132. An agent of the electronic marketplace, for example a repurposed delivery service 108, retrieves and returns 110 the item to the user-local delivery depot 130, and then causes the transfer 134 of the non-marketplace item to the consolidation site 140.

In alternative embodiments, the retrieval of the non-marketplace item may be coordinated directly from the consolidation site 140. For example, the consolidation site 140 may be designated by the consolidation module 152 as a coordinator for orders designated for consolidation thereat. Subsequently, the consolidation site 140 may communicate with user-local delivery depot 130 to arrange retrieval 110 of the item to the user-local delivery depot 130, and transfer 134 of the non-marketplace item to the consolidation site 140. Where the consolidation site 140 is local to the intended recipient 150, the consolidation site may designate an agent local to the consolidation site 140 for retrieval 110 of the item directly to the consolidation site 140 without passing through an intervening user-local delivery depot 130.

In alternative embodiments, the marketplace 112 may provide the user with an option to transfer the non-marketplace item to the consolidation site without a pickup service. In such embodiments, the electronic marketplace 112 provides the user with shipping instructions. The instructions include a shipping address for directing the item to the consolidation site (potentially via other depots or sites within the fulfillment network 120, such as user-local delivery depot 130), as well as a package identifier for inclusion on the packaging.

In some embodiments, the package identifier includes a unique identifier that associates the package with, for example, a database entry in a database 114 which contains information related to the order such as: a desired delivery date, a list of the identifiers of related items in the same order, any conditions placed on the order by the user or by the electronic marketplace, information related to the intended recipient such as an address, information related to the user such as a return address, or other information. Thus, by reference to the unique package identifier, the consolidation site 140 (or any other depots or sites within the fulfillment network 120) can communicate with the marketplace 112 by way of the network 102 and network connections 142, 118 in order to receive instructions regarding consolidation, or communicate the arrival, consolidation, or fulfillment of an order to the marketplace.

In some other alternative embodiments, the package identifier includes at least a portion of the order information so that fulfillment can be accomplished without additional communication between the consolidation site 140 and the electronic marketplace 112. Such information may include the recipient address and information regarding the items in the order. For example, a package identifier may include a unique identification number for the order, a number indicating the number of items contained in the order, and a number indicating the particular item's place in the order. For example: “123456-01/03” may indicate that order number “123456” contains 3 items, and the particular item is number 1 of 3. It will be appreciated that an identifier may take many forms without deviating from this concept and may be magnetic, a bar-code, or otherwise machine-readable. In some embodiments, a package identifier may have a machine-readable component and a human-readable component, and the components may be different. For example, the machine-readable component may include a more complete set of information about the package, and the human-readable component may include sufficient information for a technician or a recipient to troubleshoot delivery, or to determine whether a consolidated package is complete.

In various embodiments, the items are consolidated 144 at the consolidation site 140. In some embodiments, consolidation may entail repackaging the items into a single container; but consolidation may alternatively entail grouping the packages into a single delivery of multiple packages.

In accordance with some embodiments, the consolidated order may be held pending the occurrence of a fulfillment condition. Ordinarily, packages in a stream of commerce are forwarded from one site in a stream of commerce to the next as quickly as practicable after receipt. Placing a hold on an order means designating that the held item or items in the order will be retained at a specified site until a fulfillment condition is met. For example, the fulfillment condition may be the receipt of all of the items in the order, such that the consolidated order is prepared for delivery and fulfilled 146 at the next scheduled delivery departure following an effective consolidation. Therefore, a hold will be placed and maintained on the order until such a time as all items have arrived at the consolidation site, including any marketplace and any non-marketplace items. In another example, the fulfilment condition may be a particular date, such that the consolidated order is prepared for delivery and fulfilled 146 on the designated date. Thus, a hold will be placed and maintained on the order until the designated date, at which time the packages associated with the order will be grouped into a shipment and delivered. Any items that are part of the order, but have not yet arrived by this date, may be forwarded immediately upon arrival afterwards. This date may be determined by the marketplace 112 querying the user 104 for a desired delivery date; or the date may be determined automatically based on a standard formula or predetermined rule based on the date of the initiation of the order by the user. In some embodiments, a combination of such fulfilment conditions may be used.

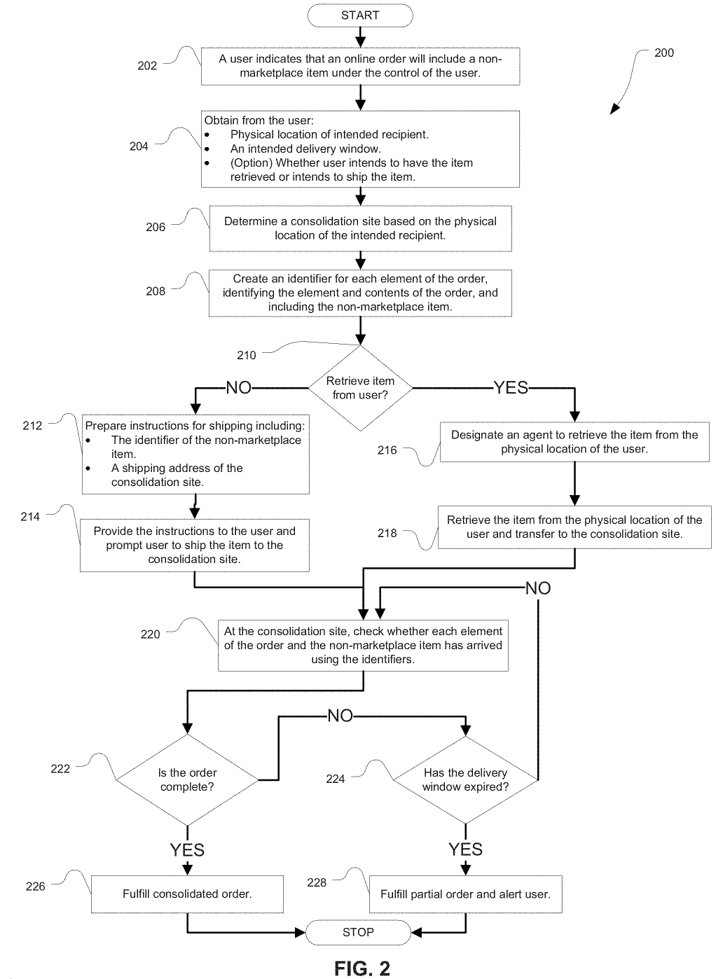

FIG. 2 is a flow chart of a process 200 for enabling the fulfillment of a combined order including a user-provided item and an order from an electronic marketplace, in accordance with embodiments. The elements of the process 200 may be enacted or triggered by executable instructions in a computer system at a consolidation module such as the consolidation module 152 (FIG. 1). In the process 200, the system is notified at 204 when a user has initiated a combined order by indicating intent to add a non-marketplace item to the order, for example at a shopping cart screen or at a checkout screen of the electronic marketplace. The electronic marketplace obtains information 204 from the user, including at least a physical location, such as an address, of the intended recipient of the order, and may also obtain an intended delivery date or range of dates. In some embodiments, the electronic marketplace may determine whether the user intends to have the user-provided item retrieved by an agent of the marketplace, in which case the electronic marketplace also obtains the physical address of the user.

The electronic marketplace determines a consolidation site 206 based in part on the physical location of the intended recipient, in accordance with embodiments. In some embodiments, the consolidation site is selected from a list of delivery depots and fulfilment centers in a logistical network associated with the electronic marketplace, and the selected site is potentially the depot or center already designated for servicing the address of the intended recipient. The electronic marketplace also creates an identifier 208 for each element of the order, including the non-marketplace item.

The electronic marketplace may determine whether to retrieve the item from the user 210 based on an expressed user preference 204 or logistical considerations, in accordance with embodiments. For example, the electronic marketplace may determine that a particular user address is outside of a covered area for package retrieval; or a user may be unable to accommodate a particular date and time for package retrieval; or an agent of the electronic marketplace may attempt to retrieve a package and be unable to obtain access. If it is determined that the item shall not or cannot be retrieved by an agent of the electronic marketplace, the electronic marketplace may prepare instructions for shipping 212 for the user, including at least an identifier for affixing on the package and a shipping address for the consolidation site. The shipping instructions are provided to the user 214, and as described above, the identifier may be human or machine-readable.

The shipping instructions may be provided in a variety of forms. For example, the instructions may take the form of an identifier and address delivered electronically, as well as instructions directing the user to mark a package containing the item with the identifier and address. The instructions may alternatively take the form of a printable or facsimile sheet, which may also include the consolidation site address and a package identifier, which may be a machine readable package identifier, as well as instructions directing the user to print and affix the sheet to the exterior of a package containing the item. In another alternative embodiment, providing the shipping instructions to the user may include mailing a sheet or attachable label having the above information, or providing packaging material for the item, which may or may not have the above shipping information already attached or printed thereon.

Alternatively, if the item is retrieved from the user, the electronic marketplace designates an agent 216 to retrieve the item from the physical location of the user, in accordance with embodiments. In some embodiments, the designated agent will be a repurposed delivery service under the control of the electronic marketplace, for example the delivery service that operates local to the user from a proximate delivery depot. When the agent has been designated, the agent will retrieve the item 218 from the physical location of the user and transfer the item to the consolidation site. The item may be transferred by way of a logistical network under the control of the electronic marketplace, or may be transferred by the use of a third-party shipping service; or in some instances, the local delivery depot of the user may be the same as the consolidation site, for example if the user and intended recipient are served by the same delivery depot.

Retrieving the item from the user may include providing packaging or instructions for packaging the item, in accordance with embodiments. For example, the user may receive instructions from the electronic marketplace to package the item prior to retrieval by the agent. In some embodiments, the packaging instructions may be the same or similar to the shipping instructions described above. In alternative embodiments, the agent may be dispatched with packaging materials and instructions for preparing the packaging, which may include an attachable label, packaging material which may or may not have a package identifier and shipping information already attached, or both.

Following transfer of the non-marketplace item to the consolidation site, the received items are checked 220 against the order to determine whether the entire order has arrived at the consolidation site. The system may be configured to check the completeness of the order at designated intervals of time, at a designated delivery date or delivery window, upon receipt of any package identified as part of an order, or based on another criterion. In some embodiments, the completeness of the order may be verified by reference to the package identifiers of each received item. In some other embodiments, the completeness of the order may be stored in a database entry under the control of the electronic marketplace, and the entry updated with the receipt of each item in the order. If the order is complete 222, the order may be fulfilled 226. In some embodiments, fulfilling the order is subject to fulfillment conditions, for example, a designated delivery date or delivery window. In such cases, the order may be held at the consolidation site until the designated delivery date. If the order is not complete, the system may check whether a delivery window or delivery date is imminent or has occurred 224, in accordance with embodiments. If the delivery window or delivery date may expire before the order is complete, the system may be configured to fulfill a partial order 228, and may additionally alert a user, and may also alert the intended recipient, that the order is incomplete. If the system determines that the delivery window or delivery date is not imminent, the system may revert to checking 220 the received items against the order after a predetermined period of time has elapsed. The system may repeat the process of checking 220 whether elements of the order have arrived on a periodic basis, e.g., daily, hourly, or more frequently. The frequency of checking may vary depending on a time of day, a logistical schedule, the immediacy of delivery window expiration or delivery date, or any other suitable criteria.

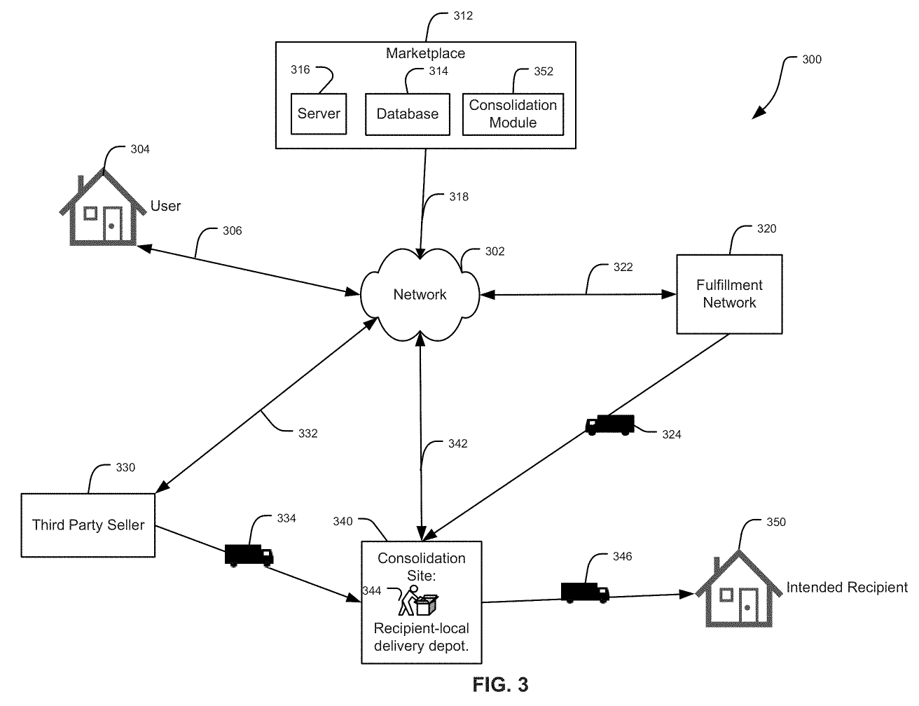

FIG. 3 is a block diagram of a system 300 for enabling the fulfillment of a combined order including a non-marketplace item and an order from an electronic marketplace, in accordance with embodiments, where the non-marketplace item is under the control of a third party unaffiliated with the electronic marketplace. In the system 300, a user 304 communicates over a network 302 and network connections 306, 318 with an electronic marketplace 312 having a web server 316, a database 314, and a consolidation module 352. Like the consolidation module 152 of FIG. 1, the consolidation module 352 in this example may be operable from physical infrastructure at a variety of locations, or may be distributed.

In accordance with embodiments, the electronic marketplace 312 may provide an option for the user 304 to include a non-marketplace item in an order, where the non-marketplace item is under the control of a third party 330 unaffiliated with either the user or the electronic marketplace. In some embodiments, this third party 330 is an online seller, and the user 304 may be in communication with the third party by way of the network 302 and network connections 306, 332. In alternative embodiments, the third party 330 may be in communication with the user by other means, for example: the third party may be a brick-and-mortar store offering shipping, and may be in communication with the user by telephone or other means; or the third party may be a seller advertising by physical catalog, in communication with the user by way of telephone, physical mail, or other means.

The user 304 is provided with shipping instructions from the electronic marketplace 312 configured for forwarding to the third-party 330, according to embodiments. The shipping instructions include at least a shipping address of the consolidation site 340 and a package identifier. The package identifier contains information configured for identifying the package as a part of a consolidated order, and may include additional information, as described above. The user 304 may also be provided with instructions for providing the package identifier and shipping address to the third party. The user 304 is prompted by the electronic marketplace 312 to place an order with the third party 330 using the supplied shipping information, such that the third party will send 334 the item to the consolidation site 340.

In alternative embodiments, the shipping information may be configured to instruct the third-party to allow an agent of the electronic marketplace to retrieve the item directly from an address of the third party 330, similar to the retrieval option described above for a user-controlled item. In such embodiments, the agent of the electronic marketplace may also provide additional packaging or labeling of the item with a package identifier and address of the consolidation site to enable transfer to the consolidation site and consolidation with any other items in the order.

A consolidation site 340 for the consolidation 344 of items in the order may be selected using any of the criteria for the selection of a consolidation site 140 (FIG. 1), in accordance with embodiments described herein. The consolidation site may, for instance, be a delivery depot under the control of the electronic marketplace that is proximate or logistically convenient based on the physical location of the intended recipient 350. The consolidation site may be in communication with the electronic marketplace 312 by way of the network 302 and network connections 342, 318.

In accordance with embodiments, the order may also have items obtained from within the electronic marketplace 312, which may be sourced from a fulfilment network 320 having the same characteristics of the fulfilment network 120 (FIG. 1). The fulfilment network 320 may be in communication with the electronic marketplace 312 by way of the network 302 and network connections 322, 318. Items obtained through the fulfilment network may be transferred 324 to the consolidation site 340, for example, using logistical channels within the fulfilment network.

The items are consolidated 344 at the consolidation site 340 as described above in the consolidation 144 of system 100 (FIG. 1). Following consolidation, the consolidated order is fulfilled 346 by delivery to the intended recipient. Fulfillment may subject to one or more fulfillment conditions, as also described above.

In alternative embodiments, the electronic marketplace 312 may provide to the user a prompt for inputting tracking data, which may include a tracking identifier or tracking number obtained from the third-party seller 330, or any other tracking data, such that a party possessing the tracking data can obtain information concerning the location or estimated delivery date of an order, or information concerning an intermediary shipper. Where tracking data are provided, the electronic marketplace 312, or the consolidation module 352, can obtain from the third-party seller 330 or from the known intermediary shipper (not shown), e.g. via the network 302, the estimated delivery date at the consolidation site 340. Using the estimated delivery date; the electronic marketplace 312, or the consolidation module 352, may determine whether an order can be fulfilled on time, in advance of actually receiving each element or before a designated delivery date or the expiration of a delivery window. In the event that an order cannot be fulfilled on time, the electronic marketplace 312, or the consolidation module 352, may alert the user that the order cannot be fulfilled on time, and may prompt the user for further instructions, e.g., to hold the order for an additional period of time in order to fulfill a complete order at a later date, to fulfill a partially consolidated order and deliver a remainder of the order at a later date, or any other suitable instruction. In some embodiments, the electronic marketplace 312 may alert a user if an alternative product exists under the control of the electronic marketplace, and may suggest that the user add the alternative product to the consolidated order. The electronic marketplace 312, or the consolidation module 352, may communicate with the fulfillment network 320 to cause a transfer 324 of the alternative product to the consolidation site; and where possible, may cause the transfer prior to the designated delivery date or expiration of the delivery window.

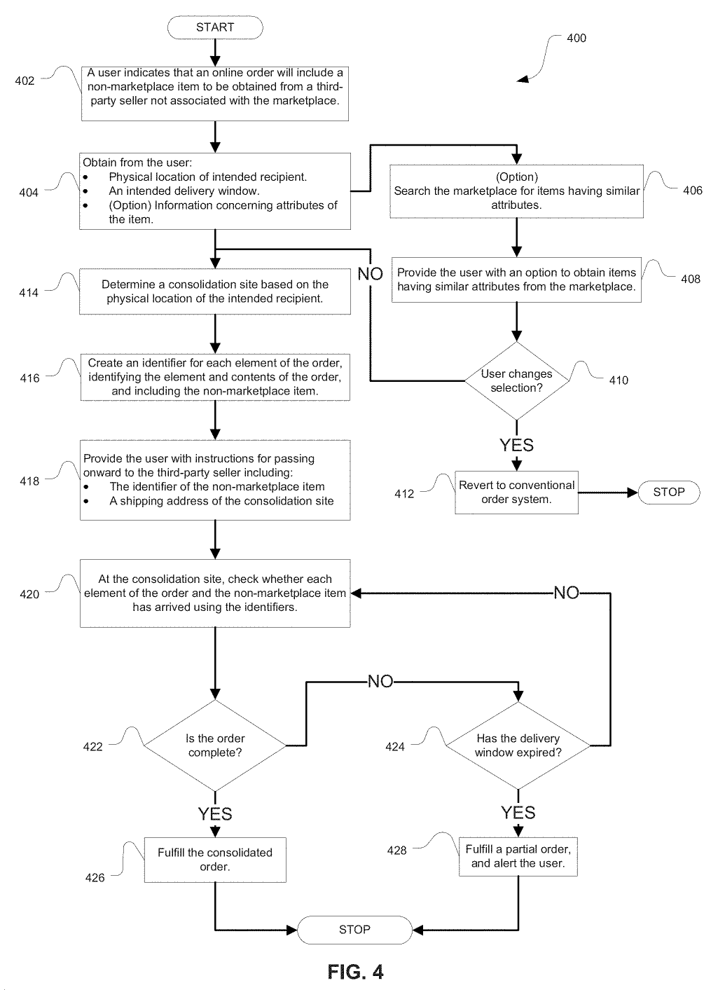

FIG. 4 is a flow chart of a process 400 for enabling the fulfillment of a combined order including a non-marketplace item and an order from an electronic marketplace, where the non-marketplace item is under the control of a third party seller unaffiliated with the electronic marketplace, in accordance with embodiments. The elements of the process 400 may be enacted or triggered by executable instructions in a computer system at a consolidation module such as the consolidation module 352 (FIG. 3). In the process 400, the system is notified when a user has initiated a combined order 402 by indicating intent to add a non-marketplace item from a third party seller to the order, for example at a shopping cart screen or at a checkout screen of the electronic marketplace. The electronic marketplace obtains information 404 from the user, including at least a physical location or address of the intended recipient of the order, and may also obtain additional information such as an intended delivery date or range of dates.

The electronic marketplace may also obtain information concerning attributes of the non-marketplace item 404 by, for example, querying the user, in accordance with embodiments. If the user provides information related to the item, the electronic marketplace may optionally search for items under the control of the electronic marketplace that may have similar attributes 406, for example from a database, and may provide the user with an option or a suggestion to substitute one or more similar items from within the electronic marketplace 408. If the user elects to change his selection from a non-marketplace item to an item from the electronic marketplace 410, the system may revert to a conventional mode 412 of fulfillment of items solely from within the electronic marketplace.

If the electronic marketplace does not receive information related to the non-marketplace item, or if the user does not change a selection to a marketplace-controlled item, then the system determines a consolidation site 414 based at least in part on the physical location or address of the intended recipient of the order, in accordance with embodiments. The system also creates a package identifier 416 for each element of the order, including the non-marketplace item, which contains at least an identifier of the order and an identifier for each particular item within the order, as described above in act 208 of process 200 (FIG. 2).

Following the determination of the consolidation site and the creation of package identifiers, the system provides instructions to the user 418 configured for forwarding to the third-party, in accordance with embodiments. The instructions include at least the package identifier for the non-marketplace item and a shipping address of the consolidation site. The user is instructed to include the package identifier and the shipping address of the consolidation site in an order placed with the third-party seller, such that both the identifier and address will appear on the exterior of a package containing the item.

At the consolidation site, the system checks whether each element of the order has arrived for consolidation 420, in accordance with embodiments. The system may be configured, for example, to update a database entry upon receipt of each item, the database entry including a list of items included in the order and a list of items received, and configured to trigger a notification that the consolidated order is complete when all of the items have arrived. Alternatively, the system may be configured to check periodically, e.g., each day, or on a particular date, whether each item has been received. The particular date may be based on an intended delivery date or delivery window designated by the user, or may be a date determined automatically or according to a formula based on, for example, the date that the order was placed.

If it is determined that the order is complete 422, the order can be fulfilled 426, subject to any pending fulfilment condition, as described herein. For example, the packages may be prepared for fulfilment but held until a fulfilment condition is met, such as the occurrence of a desired delivery date.

If it is determined that the order is not complete 422, the system may check to determine whether an intended delivery date or delivery window is imminent or has occurred 424. If a delivery date may expire before the order is complete, the system may fulfill an incomplete or partial order containing the items that have arrived on time 428, and may alert the user and/or the intended recipient that a partial order has been fulfilled.

In alternative embodiments, an order may contain non-marketplace items from both sources, e.g., one or more items under the physical control of a user and one or more items sourced from any number of third-party sellers unaffiliated with the electronic marketplace. In such embodiments, the system may generate additional shipping instructions, including additional package identifiers, for each of the non-marketplace items included in the order, as described herein.

In some alternative embodiments, an order may contain no items sourced from the electronic marketplace. For example, a user may indicate an intent to include one or more non-marketplace items with an empty electronic shopping cart of the electronic marketplace. Such embodiments may provide the user with the opportunity, for example, to provide a combined gift of an item from a third-party seller with one or more personalized items under the user's control; or may provide a platform for providing an anonymous gift, while utilizing the fulfillment and consolidation services of the fulfillment network associated with the electronic marketplace.

In any of the above-described embodiments, the system may be configured to generate an additional monetary charge for any of a selection of the above-described services, including: consolidating items, fulfilment of consolidated items, and retrieval or shipping of an item from a user or from a third party.

Some or all of the processes 200 and 400 (or any other processes described herein, or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

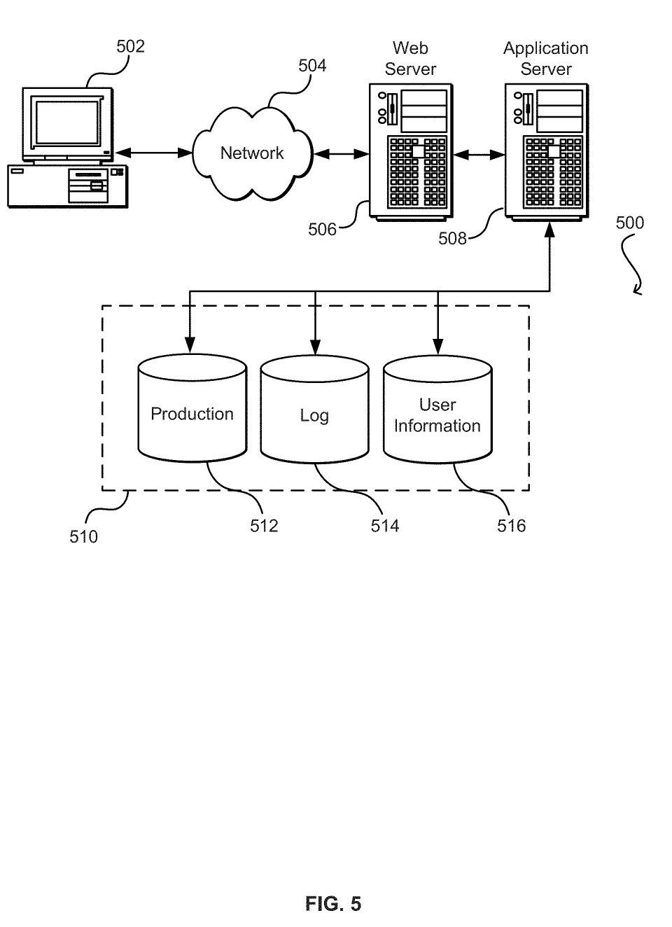

FIG. 5 illustrates aspects of an example environment 500 for implementing aspects in accordance with various embodiments. As will be appreciated, although a Web-based environment is used for purposes of explanation, different environments may be used, as appropriate, to implement various embodiments. The environment includes an electronic client device 502, which can include any appropriate device operable to send and receive requests, messages or information over an appropriate network 504 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, as the environment includes a Web server 506 for receiving requests and serving content in response thereto, although for other networks an alternative device serving a similar purpose could be used as would be apparent to one of ordinary skill in the art.

The illustrative environment includes at least one application server 508 and a data store 510. It should be understood that there can be several application servers, layers, or other elements, processes or components, which may be chained or otherwise configured, which can interact to perform tasks such as obtaining data from an appropriate data store. As used herein the term “data store” refers to any device or combination of devices capable of storing, accessing and retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device, handling a majority of the data access and business logic for an application. The application server provides access control services in cooperation with the data store and is able to generate content such as text, graphics, audio and/or video to be transferred to the user, which may be served to the user by the Web server in the form of HyperText Markup Language (“HTML”), Extensible Markup Language (“XML”) or another appropriate structured language in this example. The handling of all requests and responses, as well as the delivery of content between the client device 502 and the application server 508, can be handled by the Web server. It should be understood that the Web and application servers are not required and are merely example components, as structured code discussed herein can be executed on any appropriate device or host machine as discussed elsewhere herein.

The data store 510 can include several separate data tables, databases or other data storage mechanisms and media for storing data relating to a particular aspect. For example, the data store illustrated includes mechanisms for storing production data 512 and user information 516, which can be used to serve content for the production side. The data store also is shown to include a mechanism for storing log data 514, which can be used for reporting, analysis or other such purposes. It should be understood that there can be many other aspects that may need to be stored in the data store, such as for page image information and to access right information, which can be stored in any of the above listed mechanisms as appropriate or in additional mechanisms in the data store 510. The data store 510 is operable, through logic associated therewith, to receive instructions from the application server 508 and obtain, update or otherwise process data in response thereto. In one example, a user might submit a search request for a certain type of item. In this case, the data store might access the user information to verify the identity of the user and can access the catalog detail information to obtain information about items of that type. The information then can be returned to the user, such as in a results listing on a Web page that the user is able to view via a browser on the user device 502. Information for a particular item of interest can be viewed in a dedicated page or window of the browser.

Each server typically will include an operating system that provides executable program instructions for the general administration and operation of that server and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 5. Thus, the depiction of the system 500 in FIG. 5 should be taken as being illustrative in nature and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”) and AppleTalk. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen or keypad) and at least one output device (e.g., a display device, printer or speaker). Such a system may also include one or more storage devices, such as disk drives, optical storage devices and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.) and working memory as described above. The computer-readable storage media reader can be connected with, or configured to receive, a computer-readable storage medium, representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications and patents, cited herein are hereby incorporated by reference to the same extent as if each reference were individually and specifically indicated to be incorporated by reference and were set forth in its entirety herein.

1-4. (canceled)

5. A computer-implemented method for consolidating an online order with an additional item, comprising:
receiving, by a computer system, a user input by an online shopper indicating a request by the shopper to add one or more personal gift items to an order placed by the shopper from an electronic marketplace, the personal items being physical items under the control of and originating from the possession of the online shopper independent of the electronic marketplace;
selecting a consolidation site based at least in part on a proximity to a physical location of an intended recipient of the order;
detecting receipt of the one or more personal gift items in a first physical shipment received from the online shopper and one or more additional marketplace items in a second physical shipment at the consolidation site;
causing consolidation of the one or more personal gift items from the first physical shipment and the one or more additional marketplace items from the second physical shipment at the consolidation site to form a consolidated shipment different from the first physical shipment and second physical shipment; and
causing fulfillment of the consolidated shipment.

6. The computer implemented method of claim 5 further comprising:
comparing a received set of items at the consolidation site to a complete set of items that includes the one or more personal gift items;
determining, based at least in part on the comparing, whether the order is complete; and
maintaining a hold on the order in response to determining that the order is not complete.

7. (canceled)

8. The computer implemented method of claim 5, further comprising:
receiving, by the computer system, user input by the online shopper indicating a request by the shopper to add one or more additional third-party items from a non-marketplace order placed at a non-marketplace third party seller to the order;
providing, to the online shopper, shipping instructions for forwarding to the third party seller indicating a destination associated with the consolidation site and an identifier associated with the order.

9. The computer implemented method of claim 8, further comprising:
prompting the online shopper to input tracking data, the tracking data being associated with the non-marketplace order from the non-marketplace third party seller.

10. The computer implemented method of claim 9, further comprising:
determining, using the tracking data, a projected earliest fulfillment date.

11. (canceled)

12. The computer implemented method of claim 5, further comprising:
providing shipping instructions to the user for shipping the one or more personal gift items to the consolidation site.

13. The computer implemented method of claim 5, further comprising:
causing retrieval of the one or more personal gift items from the online shopper; and
causing transfer of the one or more personal gift items to the consolidation site.

14. (canceled)

15. The computer-implemented method of claim 5, further comprising:
receiving a user input from the online shopper indicating a desired fulfillment date; and
causing fulfillment of the consolidated shipment containing at least a subset of the one or more personal gift items on the desired fulfillment date.

16. The computer implemented method of claim 15, further comprising:
comparing the consolidated shipment to a complete set of the one or more personal gift items; and
providing a report to the user based on the comparing.

17. The computer-implemented method of claim 5, wherein
selecting a consolidation site comprises determining, from among a set of delivery depots associated with the marketplace, a delivery depot associated with deliveries to the physical location of the intended recipient; and
selecting as the consolidation site the determined delivery depot.

18. A system comprising:
one or more processors; and
memory including instructions that, when executed by the one or more processors, cause the system to, at least;
detect an order by a customer of an electronic marketplace, the order including one or more items;
receive a customization input indicating a customer intent to add a personal gift item to the order, wherein the personal gift item is a physical item under the control and in the possession of the customer independent of the electronic marketplace;
designate a consolidation site for the order based in part on a proximity to a physical location of an intended recipient of the order;
provide shipping information to the customer, the shipping information including an identifier associated with the order and a shipping address associated with the consolidation site;
provide a hold on the order associated at least with a receipt of the personal gift item in a first physical shipment received from the customer and a receipt of at least a subset of the one or more items of the order in one or more additional physical shipments at the consolidation site;
form a consolidated shipment including the first physical shipment and the one or more additional physical shipments; and
cause fulfillment of the consolidated shipment in response to detecting receipt of the personal gift item and the one or more items of the order at the consolidation site.

19. The system of claim 18, wherein the instructions further cause the system to:
receive a second customization input by the customer indicating a request by the customer to add one or more additional third-party items from a non-marketplace order placed at a non-marketplace third party seller to the order;
provide instructions for the customer to provide the identifier and the shipping address associated with the shipping information to the non-marketplace third-party seller.

20. The system of claim 18, wherein the instructions further cause the system to, at least;
receive first information related to the personal gift item;
compare the first information with second information related to one or more items under control of the marketplace;
select, at least in part based on the comparing, one or more suggested items from among the one or more items under the control of the marketplace; and
provide, to the customer, a prompt comprising the one or more suggested items.

21. The computer-implemented method of claim 5, further comprising:
providing a hold on the order associated with a receipt of a subset of the one or more additional items of the order at the selected consolidation site; and
causing a transfer of the personal item to the consolidation site in response to detecting the receipt of the subset of the one or more additional items.

22. The computer-implemented method of claim 21, further comprising receiving, by the computer system, a user input by the online shopper designating a physical location for retrieval of the personal gift item; wherein causing the transfer of the personal gift item to the consolidation site comprises causing the personal gift item to be retrieved from a physical location designated by the user.

23. The computer-implemented method of claim 21, wherein causing the transfer of the personal gift item to the consolidation site comprises providing at least shipping instructions to the customer for shipping the personal gift item, the instructions including a destination corresponding to the consolidation site.

24. The computer implemented method of claim 21, further comprising:
setting a time limit for consolidating the order; and
causing fulfillment of a partial shipment comprising one or more received items after passage of the time limit.

25. A computer-implemented method for consolidating an online order with a personal gift item, the method comprising:
presenting, by a computer system, a graphical user interface option to an online shopper assembling an order, the interface option enabling the online shopper to designate the order for consolidation with a personal gift item, the personal gift item being a physical item under the control of and in the possession of the online shopper independent of an electronic marketplace;
receiving, by the computer system, a user input by the online shopper indicating a request by the shopper to consolidate the order with the personal gift item;
selecting a consolidation site based at least in part on a proximity to a physical location of an intended recipient of the order;
detecting receipt of the personal gift item in a first physical shipment received from the online shopper and one or more additional marketplace items associated with the order in a second physical shipment at the consolidation site;
causing consolidation of the personal gift item from the first physical shipment and the one or more additional marketplace items from the second physical shipment at the consolidation site to form a consolidated shipment different from the first physical shipment and the second physical shipment; and
causing fulfillment of the consolidated shipment to the intended recipient.
